(19) United States
(12) Patent Application Publication
(10) Pub. No.: US 2014/0212160 A1
(43) Pub. Date: Jul. 31, 2014

(54) IMAGE FORMING APPARATUS

(71) Applicants: TOSHIBA TEC KABUSHIKI KAISHA, Tokyo (JP); KABUSHIKI KAISHA TOSHIBA, Tokyo (JP)

(72) Inventor: Hideaki Fukaya, Shizuoka-ken (JP)

(73) Assignees: TOSHIBA TEC KABUSHIKI KAISHA, Tokyo (JP); KABUSHIKI KAISHA TOSHIBA, Tokyo (JP)

(21) Appl. No.: 14/169,247

(22) Filed: Jan. 31, 2014

(30) Foreign Application Priority Data
Jan. 31, 2013 (JP) 2013-17188
Jan. 10, 2014 (JP) 2014-3517

(51) Int. Cl. G03G 15/20

(52) U.S. Cl. CPC G03G 15/205
USPC 399/69; 399/341; 399/321

(57) ABSTRACT

Provided is an image forming apparatus including a control unit and a heating unit for fixing an image on a recording medium and erasing the image on the recording medium. The control unit controls a heating temperature of the heating unit such that the heating temperature of the heating unit falls within any one of a first temperature range which is capable of fixing an inerasable developer, a second temperature range which is capable of fixing an erasable developer, and a fourth temperature range which satisfies both of the first temperature range and a third temperature range which is capable of erasing the erasable developer.

### CROSS-REFERENCE TO RELATED APPLICATION

This application is based upon and claims the benefit of priority from the prior Japanese Patent Application No. 2013-17188, filed on Jan. 31, 2013, the entire contents of which are incorporated herein by reference.

This application is also based upon and claims the benefit of priority from the prior Japanese Patent Application No. 2014-3517, filed on Jan. 10, 2014, the entire contents of which are incorporated herein by reference.

### FIELD

In general, an embodiment described herein relates to an image forming apparatus which has a function of forming an image on a recording medium and a function of erasing the image formed on the recording medium.

### BACKGROUND

In recent years, an image forming apparatus has been developed from the view point of resource saving, which forms an image (developer image) on a recording medium, for example, a sheet using an erasable developer and erases the image formed on the sheet. The image forming apparatus includes an erasing unit in order to erase the image. A user can form the image on the sheet by the image forming apparatus and can erase the image on the sheet by the image forming apparatus in order to reuse the sheet when the sheet formed with the image is no longer needed.

The erasable developer is decolored by being heated to a predetermined temperature or more by the erasing unit. Meanwhile, the image forming apparatus includes a fixing unit for heating the image to fix the image (developer image), which is formed on the sheet, on the sheet.

In order to reduce the number of components, an image forming apparatus including a heating unit which has both functions of the erasing unit and the fixing unit has been proposed.

The image forming apparatus separately performs an erasing operation and an image forming operation. Therefore, in a case of forming a new image by erasing the image formed on the sheet (sheet to be reused), the user performs two operations including an operation of setting the sheet to be reused once in a sheet feeding cassette of the image forming apparatus so as to erase the image and an operation of setting once again the sheet to be reused in the sheet feeding cassette so as to form an image after erasing the image on the sheet to be reused.

Accordingly, the image forming apparatus capable of erasing and forming the image by a single operation is required.

### BRIEF DESCRIPTION OF THE DRAWINGS

FIG. 1 is a cross-sectional view illustrating main parts of an image forming apparatus according to an embodiment;

FIG. 2 is a cross-sectional view illustrating a configuration of a heating unit used in the image forming apparatus according to the embodiment;

FIG. 3 is a block diagram illustrating a control configuration of the image forming apparatus according to the embodiment;

FIG. 4 is a diagram illustrating a temperature table used in the image forming apparatus according to the embodiment; and

FIG. 5 is a flowchart illustrating a control operation of the image forming apparatus according to the embodiment.

### DETAILED DESCRIPTION

According to the embodiment, an image forming apparatus having a function of forming an image on a recording medium and a function of erasing the image formed on the recording medium is provided. The image forming apparatus includes an image forming unit, a heating unit, and a control unit. The image forming unit forms the image on the recording medium using either one of a color-inerasable developer which is capable of fixing on the recording medium by being heated at a first temperature range or a color-erasable developer which is capable of fixing on the recording medium by being heated at a second temperature range and is erasable by being heated at a third temperature range. The heating unit heats the image to erase the image formed on the recording medium and to fix the image formed on the recording medium. The control unit controls the heating unit such that the heating temperature of the heating unit falls within any one of the first temperature range, the second temperature range, and a fourth temperature range which satisfies both of the first temperature range and the third temperature range.

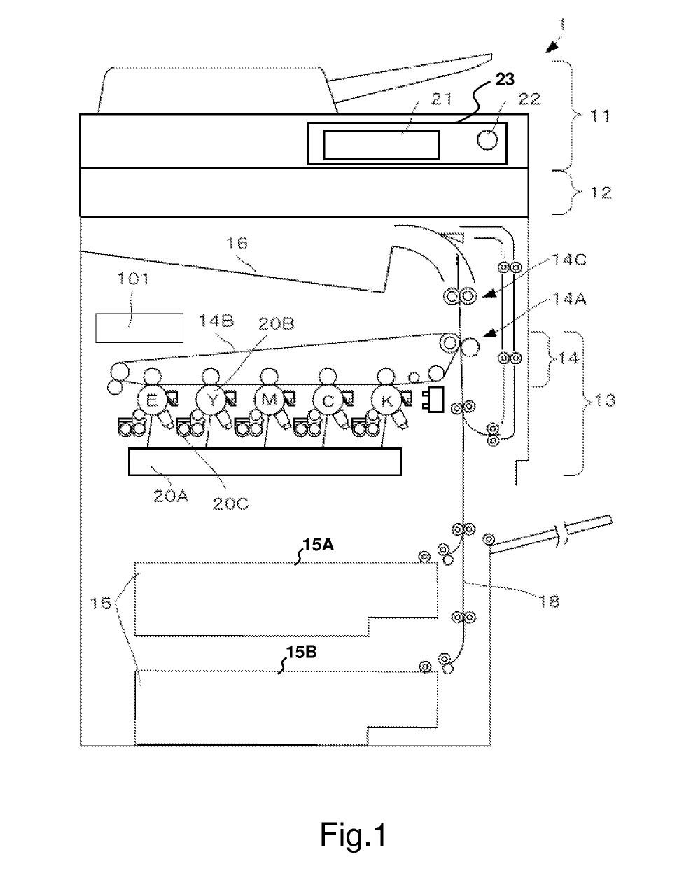

The embodiment will be described below in detail with reference with the drawings. In the drawings, the same reference numeral indicates the same or similar component. The image forming apparatus according to the embodiment will be described with reference to FIG. 1.

FIG. 1 is a cross-sectional view illustrating main parts of an image forming apparatus 1 according to the embodiment. As illustrated in FIG. 1, the image forming apparatus 1 includes a control unit 101, an operating panel 23, an automatic document feeder 11, a scanner 12, an image forming unit 13, a transfer unit 14, a sheet conveying path 18, a sheet feeding unit 15, and a heating unit 14C.

The operating panel 23 receives a various operational modes of the image forming apparatus 1 and a selection of a sheet feeding unit by a user's operation. The operating panel 23 includes, for example, a touch panel 21 for receiving various operational modes and the selection of the sheet feeding unit. The touch panel 21 is an input/output portion receiving the user's operation by a graphical user interface (GUI) system.

The operational modes of the image forming apparatus include a first image forming mode which performs an image forming operation by a color-inerasable developer, a second image forming mode which performs the image forming operation by a color-erasable developer, and a third image forming mode which performs the image forming operation by the inerasable developer together with an image erasing operation.

The operating panel 23 receives start instruction of various operations by the user's operation and outputs a start instruction signal to the control unit 101. The operating panel 23 has a start button 22 to receive the start instruction of various operations by a pressing operation of a user.

When the operating panel 23 receives the selection of the operational mode, for example, the first image forming mode by the touch panel 21 and receives the start instruction by the start button 22, the image forming apparatus 1 starts the image forming operation by the inerasable developer.

The automatic document feeder 11 is installed at an upper part of the image forming apparatus 1 body to open and close. The automatic document feeder 11 has a document conveyance mechanism which takes out documents one by one from a sheet feed tray and conveys the taken document to a sheet discharging tray through a document reader of the scanner 12.

In order to read out an image of the document by the scanner 12, the automatic document feeder 11 conveys the document to the document reader by the document conveyance mechanism. The image forming apparatus 1 can read out the document, which is placed on a document platen of the scanner 12 by the user, through the scanner 12. The automatic document feeder 11 is opened at the time of placing the document on the document platen and is closed at the time of reading out the image of the document through the scanner 12.

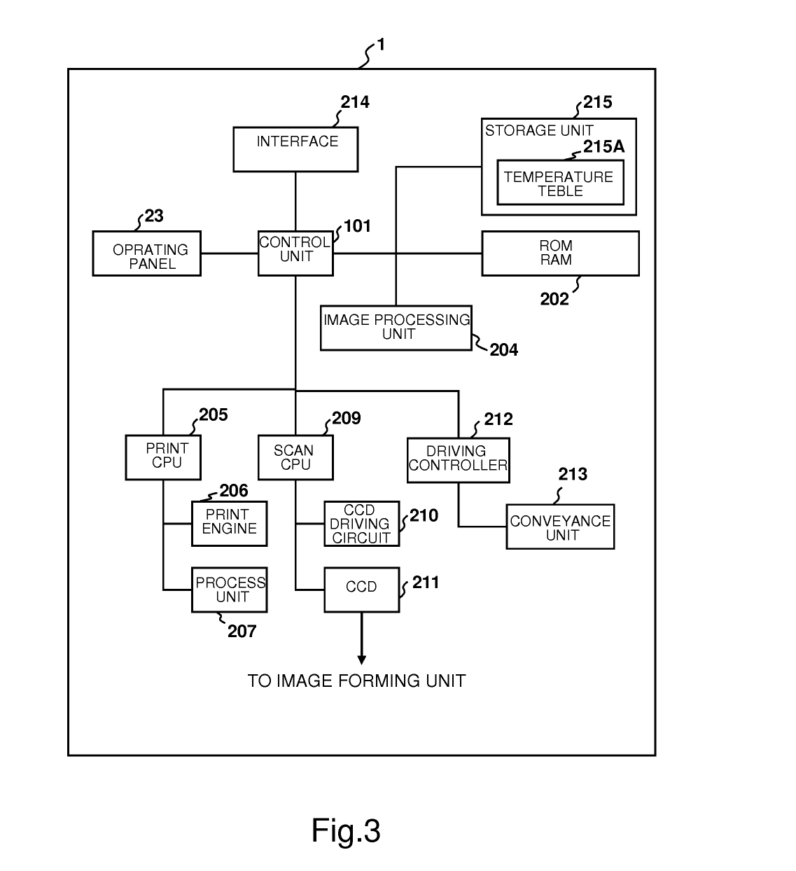

The scanner 12 includes a first carriage, a second carriage, a lens block, and a charge coupled device (CCD) 211 (see FIG. 3) as an image reading sensor in addition to the document reader and the document platen. The first carriage has an exposure lamp and a first reflecting mirror and reciprocates along the document platen. The second carriage has a plurality of second reflecting mirrors.

The first carriage reciprocates along the document platen at the time of reading out the image of the document placed on the document platen and stops at a position of the document reader at the time of reading out the image of the document to be conveyed by the automatic document feeder 11. The second carriage reciprocates in accordance with the movement of the first carriage. The exposure lamp exposes the document. The first reflecting mirror receives light reflected from the document and reflects the received light to the second reflecting mirror. The second reflecting mirror receives light reflected from the first mirror and reflects the received light to the lens block. The lens block performs an optically variable power operation on light reflected from the second reflecting mirror and projects the light onto the CCD 211. The CCD 211 converts the light image projected from the lens block into an electrical signal and outputs the converted light image to the image forming unit 13 as an image signal.

The image forming unit 13 forms the image on a sheet by an electrophotographic system using the inerasable developer, for example, a yellow toner Y, a magenta toner M, a cyan toner C, or a black toner K and the erasable developer, for example, a blue toner E. The image forming unit 13 includes a laser irradiation unit 20A, process units 207 (see FIG. 3), and the transfer unit 14. The process units 207 are made up of five units, which are disposed in a line for each color, to form an image (toner image) of each color. Each of the process units 207 includes a photosensitive drum 20B and a processing unit such as a developing unit 20C provided around the photosensitive drum 20B. The developing unit 20C includes a developer cartridge which contains a toner of each color. In order to replace with a new cartridge when the toner is consumed and becomes empty, the developer cartridge is detachably provided in the image forming apparatus 1.

The inerasable developers, for example, the yellow toner Y, the magenta toner M, the cyan toner C, the black toner K are well-known toners to be used in forming the image by the electrophotographic system. Hereinafter, the inerasable developer is referred to as a general toner.

The general toner is heated to, for example, a first temperature range of 170° C. to 200° C. and can be fixed on the sheet.

The erasable developer, for example, the toner E includes a coloring compound, a color developing agent, and a decolorizing agent. An example of the coloring compound may be a leuco dye. An example of the color developing agent may be phenols. The decolorizing agent may include a substance which is compatible with the coloring compound when being heated and has no affinity with the color developing agent.

The toner E produces a color by an interaction between the coloring compound and the color developing agent and is decolored by the heating to a predetermined temperature or more such that the interaction between the coloring compound and the color developing agent is finished.

The erasable toner E is heated to a second temperature range of 150° C. to 160° C. lower than the first temperature range and can be fixed on the sheet. Furthermore, the erasable toner E is heated to a third temperature range of 190° C. to 220° C. and can be erasable by decoloring.

The laser irradiation unit 20A irradiates the photosensitive drum 20B, which is uniformly charged in advance, with laser light for each color based on the image signal to form an electrostatic latent image on the photosensitive drum 20B. The developing unit 20C of each of the process units 207 supplies the toner of each color to the photosensitive drum 20B and develops the electrostatic latent image to form the toner image of each color on the photosensitive drum 20B.

Each of the process units 207 operates according to the selection of the operational mode received by the operating panel 23. When the operating panel 23 receives the selection of the first image forming mode or the third image forming mode, the process units 207 for the general toners Y, M, C, and K operate. The process units 207 for the general toners Y, M, C, and K form the images of the toners Y, M, C, and K on the photosensitive drum 20B. When the operating panel 23 receives the selection of the second image forming mode, the process unit 207 for the erasable toner E operates. The process unit 207 for the toner E forms the image of the toner E on the photosensitive drum 20B.

The sheet feeding unit 15 includes an upper sheet feeding cassette 15A and a lower sheet feeding cassette 152 which are detachably provided at a lower part of the image forming apparatus 1 body. The sheet feeding cassettes 15A and 15B accommodate different types of sheets to form the image, respectively.

For example, the user can set what kinds of sheets to be accommodated in the sheet feeding cassettes 15A and 15B by the operation of the operating panel 23, in advance. In the embodiment, for example, the sheet feeding cassette 15A is set to accommodate only a first sheet of which neither one of the surfaces is not formed with the image. The sheet feeding cassette 15B is set to accommodate only a second sheet of which one surface is previously formed with the image using the erasable toner E.

In FIG. 1, since both surfaces of the first sheet are not formed with the image, the first sheet may be set in the sheet feeding cassette 158 in a state where either of both surfaces faces upward or downward.

In FIG. 1, on the other hand, when the second sheet is set in the sheet feeding cassette 15B in a state where one surface faces downward, the other surface of the second sheet comes in contact with a transfer belt 14B at a transfer position which will be described below. In order words, the toner image is transferred onto the other surface of the second sheet. In FIG. 1, furthermore, when the second sheet is set in the sheet feeding cassette 15B in a state where one surface of the second sheet faces upward, one surface of the second sheet comes in contact with the transfer belt 14B at the transfer position. That is, the toner image is transferred onto one surface of the second sheet. As described above, since the image using the erasable toner E is previously formed on one surface of the second sheet, the toner image is superimposingly transferred onto the image using the erasable toner E from the transfer belt 14B.

In the following description, accordingly, the state where the second sheet is set in the sheet feeding cassette 15B so that one surface of the second sheet faces downward is called a correct set state, whereas the state where the second sheet is set in the sheet feeding cassette 15B so that one surface of the second sheet faces upward is called an erroneous set state. In the following description, furthermore, the surface of the sheet onto which the toner image is transferred from the transfer belt 14B is called a transfer surface.

The image forming apparatus 1 distinguishes between the sheet feeding cassette 15A in which the first sheet is accommodated and the sheet feeding cassette 15B in which the second sheet is accommodated according to, for example, the set result by the user. The image is formed on the sheet accommodated in one sheet feeding cassette of the sheet feeding cassette 15A and the sheet feeding cassette 15B according to the selection of the user which is received in the operating panel 23.

The sheet feeding unit 15 includes a sheet feeding roller and a separation roller with respect to each of the sheet feeding cassettes 15A and 15B. The sheet feeding roller takes out the sheet from the sheet feeding cassettes 15A and 15B. The separation roller separates the sheet taken out by the sheet feeding roller one by one and feeds the separated sheet to the sheet conveying path 18.

The sheet conveying path 18 guides the sheet to the sheet discharging tray 16 from the sheet feeding cassettes 15A and 158 through the position of a transfer roller 14A of the transfer unit 14 and the heating unit 14C. The image forming apparatus 1 has a conveyance unit 213 (see FIG. 3) which conveys the sheet in the sheet conveying path 18. The conveyance unit 213 has a plurality of conveyance rollers provided along the sheet conveying path 18. The conveyance unit 213 conveys the sheet supplied from the sheet feeding cassettes 15A and 15B to the position of the transfer roller 14A.

The transfer unit 14 has the transfer roller 14A, the transfer belt 14B and the like. The transfer unit 14 sequentially superimposes the toner image of each color and transfers the superimposed toner image onto the transfer belt 14B from the photosensitive drum 20B of each process unit 207. The transfer belt 14B is disposed along the photosensitive drum 20B of each process unit 207, carries the toner image, and endlessly travels. In the conveying path 18, the transfer roller 14A comes in contact with the transfer belt 14B, and the sheet is conveyed by being nipped between the transfer roller 14A and the transfer belt 14B. As a transfer voltage is applied, the transfer roller 14A transfers the toner image onto the sheet being conveyed from the transfer belt 14B. Hereinafter, the position where the transfer roller 14A and the transfer belt 14B come in contact with each other is called a transfer position.

The conveyance unit 213 conveys the sheet onto which the toner image is transferred to the heating unit 14C in conjunction with the transfer unit 14.

The heating unit 14C is provided at a downstream position from the transfer roller 14A in the conveyance direction of the sheet. The heating unit 14C changes a heating temperature for heating the toner image of the sheet according to the operational mode. When the operating panel 23 receives the selection of the first image forming mode or the second image forming mode, the heating unit 14C pressurizes and heats the toner image at the heating temperature of the first temperature range or the second temperature range to fix the images of the toners Y, M, C, and K or the image of the toner E on the sheet. When the operating panel 23 receives the selection of the third image forming mode, the heating unit 14C pressurizes and heats the toner image at a fourth temperature range which satisfies both of the first temperature range and the third temperature range. The heating unit 14C fixes the images of the toners Y, M, C, and K on the sheet while erasing the image of the toner E on the sheet.

The conveyance unit 213 discharges the heat-treated sheet to the sheet discharging tray 16 from a sheet discharging port of the image forming apparatus 1 in conjunction with the transfer unit 14 and the heating unit 14.

The sheet discharging tray 16 holds the sheet, which is discharged by being heat-treated with the heating unit 14C, in a stacked state.

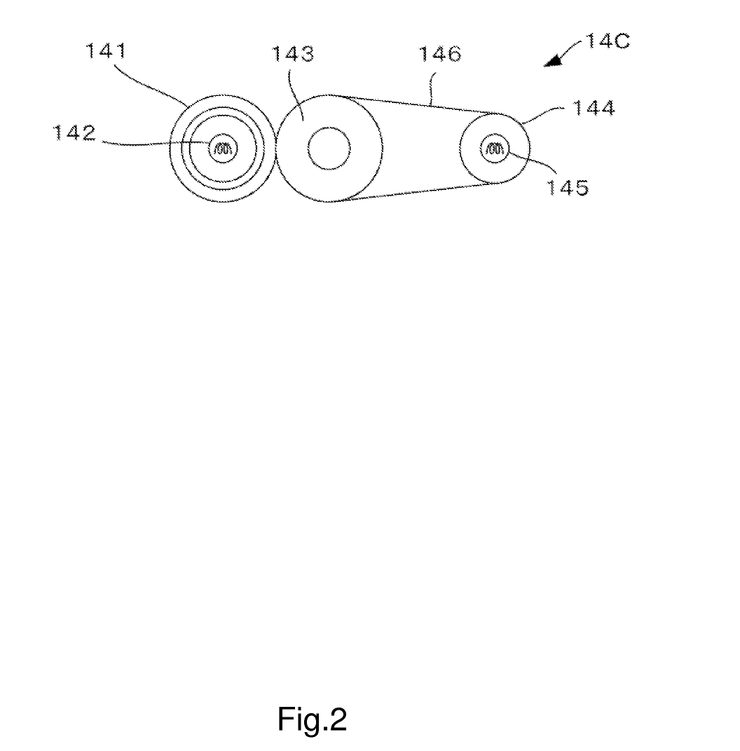

The heating unit 14C will be described in more detail with reference to FIG. 2. FIG. 2 is a cross-sectional view illustrating a configuration of the heating unit 14C. As illustrated in FIG. 2, the heating unit 14C includes, for example, a first heating roller 141, a pressure roller 143, a second heating roller 144, and a heat transfer belt 146. The first heating roller 141 has a first heating element 142 therein. The first heating roller 141 is disposed opposite to the pressure roller 143. The first heating roller 141 comes in contact with the heat transfer belt 146 at a position opposite to the pressure roller 143. The pressure roller 143 applies pressure to the heat transfer belt 146 at a position opposite to the first heating roller 141 in a direction where the heat transfer belt 146 is pressed against the first heating roller 141. The second heating roller 144 has a second heating element 145 therein. The heat transfer belt 146 is stretched between the second heating roller and the pressure roller 143 and rotates while holding the heat conducted from the second heating roller 144. The heating unit 14C conveys the sheet while nipping the sheet between the first heating roller 141 and the heat transfer belt 146 to heat and pressurize the toner image of the sheet.

Therefore, the heating unit 14C can heat the toner image formed on the transfer surface of the sheet opposite to the first heating roller 141 by the first heating roller 141. The heating unit 14C can heat the toner image formed on a non-transfer surface (surface corresponding to the other side of the transfer surface) opposite to the heat transfer belt 146 by the heat transfer belt 146.

The heating unit 14C heats from at least one surface of the sheet. For example, in the case of the first image forming mode or the second image forming mode, the heating unit 14C heats the sheet at the heating temperature of the first temperature range or the second temperature range to fix the images of the toners Y, M, C, and K or the image of the toner E on the sheet.

Specifically, in the case of the first image forming mode or the second image forming mode and when the sheet is fed from the sheet feeding cassette 15A, the heating unit 14C fixes the images of the toners Y, M, C, and K or the image of the toner E on the transfer surface of the first sheet. The toner image does not exist in the non-transfer surface of the first sheet having the transfer surface on which the toner image is fixed.

In the case of the first image forming mode or the second image forming mode and when the sheet is fed from the sheet feeding cassette 15B, the heating unit 14C fixes the images of the toners Y, M, C, and K or the image of the toner E on the transfer surface of the second sheet.

When the second sheet is set in the sheet feeding cassette 15B in the correct set state, one surface, which is previously formed with the image of the toner E, becomes the non-transfer surface of the second sheet. Accordingly, the previously formed image of the toner E remains in the non-transfer surface of the second sheet having the transfer surface on which the toner image is fixed.

When the second sheet is set in the sheet feeding cassette 15B in the erroneous set state, one surface, which is previously formed with the image of the toner E, becomes the transfer surface of the second sheet. Accordingly, the images of the toners Y, M, C, and K or the image of the toner E are fixed on the transfer surface of the second sheet in a state of being superimposed with the previously formed image of the toner E.

Furthermore, for example, in the case of the third image forming mode, the heating unit 14C erases the image of the toner E on the sheet and also fixes the images of the toners Y, M, C, and K on the sheet by heating the sheet at the heating temperature of the fourth temperature range.

Specifically, in the third image forming mode and when the sheet is fed from the sheet feeding cassette 15A, the heating unit 14C fixes the images of the toners Y, M, C, and K on the transfer surface of the first sheet. The toner image does not exist in the non-transfer surface of the first sheet having the transfer surface on which the toner image is fixed.

In the case of the third image forming mode and when the sheet is fed from the sheet feeding cassette 15B, the heating unit 14C fixes the images of the toners Y, M, C, and K on the transfer surface of the second sheet.

When the second sheet is set in the sheet feeding cassette 15B in the correct set state, one surface, which is previously formed with the image of the toner E, becomes the non-transfer surface of the second sheet. As described above, the heating unit 14C can also heat the non-transfer surface of the sheet. Furthermore, in the case of the third image forming mode, the heating temperature of the heating unit 14C is the fourth temperature range. Accordingly, the image of the toner E, which is previously formed on the non-transfer surface of the second sheet having the transfer surface on which the toner image is fixed, is erased. That is, in the third image forming mode and when the sheet is fed from the sheet feeding cassette 15B (in the case of the correct set state), the heating unit 14C erases the image of the toner E on one surface (non-transfer surface) of the second sheet and also fixes the images of the toners Y, M, C, and K on the other surface (transfer surface) of the second sheet.

When the second sheet is set in the sheet feeding cassette 15B in the erroneous set state, one surface, which is previously formed with the image of the toner E, becomes the transfer surface of the second sheet. As described above, in the case of the third image forming mode, the heating temperature of the heating unit 14C is the fourth temperature range. Accordingly, the image of the toner E, which is previously formed on the transfer surface of the second sheet on which the toner image is fixed, is erased. That is, in the third image forming mode and when the sheet is fed from the sheet feeding cassette 15B (in the case of the erroneous set state), the heating unit 14C erases the image of the toner E on one surface (transfer surface) of the first sheet and also fixes the toner image on one surface (transfer surface) of the second sheet.

A control configuration of the image forming apparatus 1 will be described with reference to FIG. 3. FIG. 3 is a block diagram illustrating the control configuration of the image forming apparatus 1. As illustrated in FIG. 3, the image forming apparatus 1 has a main central processing unit (CPU) as a control unit 101. The image forming apparatus 1 includes a memory 202 made up of a read only memory (ROM), a random access memory (RAM) or the like, an image processing unit 204, and a storage unit 215 made up of a hard disk drive (HDD) or the like. The control unit 101 is connected to the memory 202, the image processing unit 204, and the storage unit 215. The control unit 101 is connected to the operating panel 23. The control unit 101 is connected to an external device through the interface 214.

Furthermore, the image forming apparatus 1 includes a print CPU 205, a scan CPU 209, and a driving controller 212. The control unit 101 is connected to the print CPU 205, the scan CPU 209, and the driving controller 212.

The print CPU 205 is connected to a print engine 206 including the image forming unit 13, the transfer unit 14, and the sheet feeding unit 15, and the process unit 207. The print CPU 205 controls the print engine 206 and the process unit 207.

The scan CPU 209 is connected to the CCD 211 and a CCD driving circuit 210 for driving the CCD 211. The scan CPU 209 controls the CCD 211 and the CCD driving circuit 210. The CCD 211 outputs the image signal to the image forming unit.

The driving controller 212 controls the conveyance unit 213 which conveys the sheet.

The storage unit 215 has a temperature table 215A which stores data of the heating temperature of the heating unit 14C for each of the operational modes.

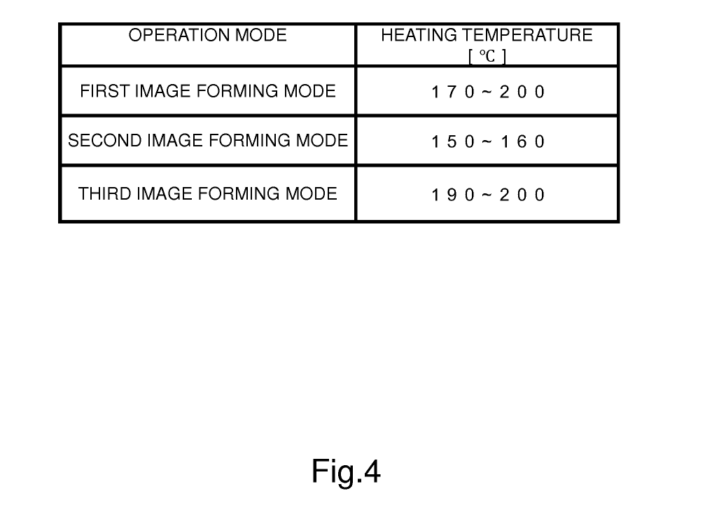

The temperature table 215A will be described with reference to FIG. 4. FIG. 4 is a diagram illustrating the temperature table 215A used in the image forming apparatus 1. As illustrated in FIG. 4, the temperature table 215A stores data of the first temperature range which is the heating temperature of the first image forming mode. The temperature table 215A stores data of the second temperature range which is the heating temperature of the second image forming mode. The temperature table 215A stores data of the fourth temperature range which is the heating temperature of the third image forming mode.

Specifically, the first temperature range which is the heating temperature of the first image forming mode is 170° C. to 200° C. The second temperature range which is the heating temperature of the second image forming mode is 150° C. to 160° C. The fourth temperature range which is the heating temperature of the third image forming mode is 190° C. to 200° C.

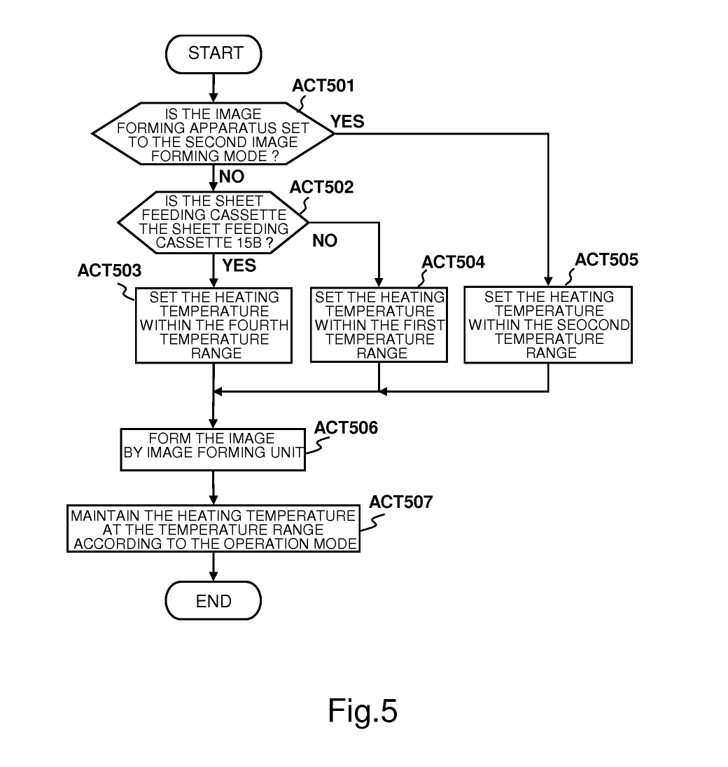

A control operation in the first to third image forming modes of the image forming apparatus 1 will be described with reference to FIG. 5. FIG. 5 is a flowchart illustrating the control operation of the image forming apparatus 1. The following control operation indicates a control operation in a case where the start button 22 is previously operated by the user. As illustrated in FIG. 5, in ACT 501, the control unit 101 determines whether the operational mode of the image forming apparatus 1 is the second image forming mode.

Specifically, the control unit determines whether the operating panel 23 receives the selection of the second image forming mode from the user. As described above, the second image forming mode is an operational mode of the image forming apparatus 1 which forms the image using the erasable developer (erasable toner E).

When the control unit 101 determines that the operational mode of the image forming apparatus 1 is the second image forming mode (YES in ACT 501), the operation of the image forming apparatus 1 proceeds to ACT 505. When the control unit 101 determines that the operational mode of the image forming apparatus 1 is not the second image forming mode (NO in ACT 501), the operation of the image forming apparatus 1 proceeds to ACT 502.

In ACT 502, the control unit 101 determines whether the sheet feeding cassette for feeding the sheet is the sheet feeding cassette 15A or the sheet feeding cassette 15B. In order words, the control unit 101 selects either one of the sheet feeding cassette 15A and the sheet feeding cassette 15B. As described above, the sheet feeding cassette 15A is a sheet feeding cassette which accommodates the first sheet. As described above, the first sheet is a sheet of which neither one of the surfaces is formed with the image.

As described above, the sheet feeding cassette 15B is a sheet feeding cassette which accommodates the second sheet. As described above, the second sheet is a sheet of which one surface is previously formed with the image using the erasable toner E and the other surface is not formed with the image.

In ACT 502, specifically, the control unit 101 determines whether the operating panel 23 receives the selection of the sheet feeding cassettes 15A and 15B from the user.

When the operating panel 23 receives the selection of the sheet feeding cassette 15A, the control unit 101 determines whether the first sheet having a predetermined size is accommodated in the sheet feeding cassette 15A based on a detection result of, for example, a sensor (not illustrated). When the first sheet having the predetermined size is accommodated in the sheet feeding cassette 15A, the control unit 101 determines that the sheet feeding cassette for feeding the sheet is the sheet feeding cassette 15A (NO in ACT 502) in ACT 502. When the first sheet having the predetermined size is not accommodated in the sheet feeding cassette 15A, the control unit 101 allows the operating panel 23 to display the fact, for example, that the first sheet is not accommodated in the sheet feeding cassette 15A.

On the other hand, when the operating panel 23 receives the selection of the sheet feeding cassette 15B, the control unit 101 determines whether the second sheet having a predetermined size is accommodated in the sheet feeding cassette 15B based on the detection result of, for example, the sensor (not illustrated). When the second sheet having the predetermined size is accommodated in the sheet feeding cassette 15B, the control unit 101 determines that the sheet feeding cassette for feeding the sheet is the sheet feeding cassette 15B (YES in ACT 502) in ACT 502. When the second sheet having the predetermined size is not accommodated in the sheet feeding cassette 15B, the control unit 101 allows the operating panel 23 to display the fact, for example, that the second sheet is not accommodated in the sheet feeding cassette 15B.

Moreover, when the operating panel 23 does not receive the selection of the sheet feeding cassettes 15A and 15B, the control unit 101 determines whether the second sheet having a predetermined size is accommodated in the sheet feeding cassette 15B. When the second sheet having the predetermined size is accommodated in the sheet feeding cassette 15B, the control unit 101 determines that the sheet feeding cassette for feeding the sheet is the sheet feeding cassette 15B (YES in ACT 502) in ACT 502.

When the second sheet having the predetermined size is not accommodated in the sheet feeding cassette 15B, the control unit 101 determines whether the first sheet having the predetermined size is accommodated in the sheet feeding cassette 15A. When the first sheet having the predetermined size is accommodated in the sheet feeding cassette 15A, the control unit 101 determines that the sheet feeding cassette for feeding the sheet is the sheet feeding cassette 15A (NO in ACT 502) in ACT 502. When the first sheet having the predetermined size is not accommodated in the sheet feeding cassette 15A, the control unit 101 allows the operating panel 23 to display the fact, for example, that the sheet is not accommodated in the sheet feeding cassette.

In ACT 502, when the control unit 101 determines that the sheet feeding cassette for feeding the sheet is the sheet feeding cassette 15A (NO in ACT 502), the operation of the image forming apparatus 1 proceeds to ACT 504. When the control unit 101 determines that the sheet feeding cassette for feeding the sheet is the sheet feeding cassette 15B (YES in ACT 502), the operation of the image forming apparatus 1 proceeds to ACT 503.

In ACT 503, the control unit 101 reads out data of the fourth temperature range corresponding to the third image forming mode from the temperature table 215A. The control unit 101 controls the first heating element 142 and the second heating element 145 of the heating unit 14C such that the heating temperature of the heating unit 14C falls within the fourth temperature range. As described above, the fourth temperature range is a temperature range which satisfies both of the first temperature range at which the general toners Y, M, C, and K are capable of fixing and the third temperature range at which the erasable toner E is erasable.

In ACT 504, the control unit 101 reads out data of the first temperature range corresponding to the second image forming mode from the temperature table 215A. The control unit 101 controls the first heating element 142 and the second heating element 145 of the heating unit 14C such that the heating temperature of the heating unit 14C falls within the first temperature range.

In ACT 505, the control unit 101 determines whether the sheet feeding cassette for feeding the sheet is the sheet feeding cassette 15A or the sheet feeding cassette 15B, as in ACT 502. Specifically, as described above, when the operating panel 23 receives the selection of the sheet feeding cassettes 15A and 15B, the control unit 101 determines whether the sheet having the predetermined size is accommodated in the sheet feeding cassettes 15A and 15B selected by the user to determine the sheet feeding cassette for feeding the sheet. Moreover, when the operating panel 23 does not receive the selection of the sheet feeding cassettes 15A and 15B, the control unit 101 determines whether the first sheet is accommodated in the sheet feeding cassette 15A. When the first sheet is not accommodated in the sheet feeding cassette 15A, the control unit 101 determines whether the sheet is accommodated in the sheet feeding cassette 15B. The control unit 101 determines whether the sheet is accommodated in the sheet feeding cassettes 15A and 15B to determine the sheet feeding cassette for feeding the sheet.

For example, when determining that the sheet feeding cassette for feeding the sheet is the sheet feeding cassette 15B, the control unit 101 allows the operating panel 23 to display a message for urging the user to confirm whether the second sheet within the sheet feeding cassette 15B is set in the correct set state.

In ACT 505, after determining the sheet feeding cassette, the control unit 101 reads out data of the second temperature range corresponding to the second image forming mode from the temperature table 215A. The control unit 101 controls the first heating element 142 and the second heating element 145 of the heating unit 14C such that the heating temperature of the heating unit 14C falls within the second temperature range.

In ACT 506, the control unit 101 determines that the heating temperature of the heating unit 14C becomes a temperature range according to the operational mode to control the operation of the image forming unit 13, the sheet feeding unit 15, the conveyance unit 213, the transfer unit 14 and so on. The sheet feeding unit 15 feeds the sheet from the sheet feeding cassettes 15A and 15B determined by the control unit 101. The conveyance unit 213 conveys the sheet fed from the sheet feeding cassettes 15A and 15B to the transfer position. The toner image is transferred onto the transfer surface of the sheet according to the operational mode.

In ACT 507, the control unit 101 controls the first heating element 142 and the second heating element 145 of the heating unit 14C such that the heating temperature of the heating unit 14C is maintained at the temperature range according to the operational mode. The heating unit 14C heats the toner image, which is formed on the sheet, at the temperature range.

For example, when the operational mode of the image forming apparatus 1 is the first image forming mode, the heating unit 14C heats the images of the general toners Y, M, C, and K, which are formed on the transfer surface of the first sheet, at the first temperature range to fix the images of the general toners Y, M, C, and K on the first sheet.

For example, when the operational mode of the image forming apparatus 1 is the second image forming mode, the heating unit 14C heats the image of the erasable toner E, which is formed on the transfer surface of the first sheet or the second sheet, at the second temperature range to fix the image of the erasable toner E on the first sheet or the second sheet.

For example, when the operational mode of the image forming apparatus 1 is the third image forming mode and when the second sheet is set in the sheet feeding cassette 15B in the correct set state, one surface of the second sheet becomes the non-transfer surface and the other surface becomes the transfer surface. Therefore, the heating unit 14C heats the image of the erasable toner E, which is previously formed on one surface of the second sheet, at the fourth temperature range to erase the image of the erasable toner E. Simultaneously, the heating unit 14C heats the images of the general toners Y, M, C, and K, which are formed on the other surface of the second sheet, at the fourth temperature range to fix the images of the general toners Y, M, C, and K on the other surface of the second sheet.

For example, when the operational mode of the image forming apparatus 1 is the third image forming mode and when the second sheet is set in the sheet feeding cassette 15B in the erroneous set state, since one surface of the second sheet becomes the transfer surface, the transfer unit 14 transfers the images of the general toners Y, M, C, and K onto one surface of the second sheet. Accordingly, the images of the general toners Y, M, C, and K are formed on one surface of the second sheet by superimposing with the image of the erasable toner E, which is previously formed. Thus, the heating unit 14C heats the image of the erasable toner E and the images of the general toners Y, M, C, and K formed on one surface of the second sheet at the fourth temperature range to erase the image of the erasable toner E and to also fix the images of the general toners Y, M, C, and K on one surface of the second sheet.

As described above, according to the embodiment, the image forming apparatus having a function of forming the image on a recording medium and a function of erasing the image formed on the recording medium is provided. The image forming apparatus includes the image forming unit, the heating unit, and the control unit. The image forming unit forms the image on the recording medium using either one of a color-inerasable developer which is capable of fixing on the recording medium by being heated at the first temperature range or a color-erasable developer which is capable of fixing on the recording medium by being heated at the second temperature range and is erasable by being heated at the third temperature. The heating unit heats the image to erase the image formed on the recording medium and to fix the image formed on the recording medium. The control unit controls the heating unit such that the heating temperature of the heating unit falls within any one of the first temperature range, the second temperature range, and the fourth temperature range which satisfies both of the first temperature range and the third temperature range.

Therefore, according to the embodiment, the user can erase the image formed previously on the sheet and form the image on the sheet by a single operation.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An image forming apparatus comprising:
an image forming unit configured to form an image on a recording medium using either one of a color-inerasable developer which is capable of fixing on the recording medium by being heated at a first temperature range or a color-erasable developer which is capable of fixing on the recording medium by being heated at a second temperature range and is color-erasable by being heated at a third temperature range;
a heating unit configured to heat the image to erase the image formed on the recording medium and configured to fix the image formed on the recording medium; and
a control unit configured to control the heating unit such that a heating temperature of the heating unit falls within any one of the first temperature range, the second temperature range, and a fourth temperature range which satisfies both of the first temperature range and the third temperature range.

2. The image forming apparatus according to claim 1, wherein the control unit controls the heating unit such that the heating temperature of the heating unit falls within the first temperature range when the image formed on the recording medium using the inerasable developer is fixed on the recording medium.

3. The image forming apparatus according to claim 1, wherein the control unit controls the heating unit such that the heating temperature of the heating unit falls within the second temperature range when the image formed on the recording medium using the erasable developer is fixed on the recording medium.

4. The image forming apparatus according to claim 1, wherein the control unit controls the heating unit such that the heating temperature of the heating unit falls within the fourth temperature range when the image formed on the recording medium using the inerasable developer is fixed on the recording medium and when the image formed on the recording medium using the erasable developer is erased.

5. The image forming apparatus according to claim 4, wherein the control unit controls the heating unit such that the heating temperature of the heating unit falls within the fourth temperature range when an image formed on one surface of the recording medium using the erasable developer is erased and when an image formed on the other surface of the recording medium using the inerasable developer is fixed on the recording medium.

6. The image forming apparatus according to claim 4, wherein the control unit controls the heating unit such that the heating temperature of the heating unit falls within the fourth temperature range when an image formed on one surface of the recording medium using the erasable developer is erased and when the image formed on the one surface of the recording medium using the inerasable developer is fixed on the recording medium.

7. The image forming apparatus according to claim 1, further including:
a sheet feeding unit that feeds a first recording medium of which both surfaces are not formed with an image and a second medium of which one surface is formed with an image using the erasable developer and the other surface is not formed with an image and feeds either one of the first recording medium or the second recording medium to the image forming unit.

8. The image forming apparatus according to claim 7, wherein the control unit controls the heating unit such that the heating temperature of the heating unit falls within the second temperature range when the image forming unit forms an image on the first recording medium or the second recording medium using the erasable developer.

9. The image forming apparatus according to claim 7, wherein the control unit controls the heating unit such that the heating temperature of the heating unit falls within the first temperature range when the image forming unit forms an image on the first recording medium using the inerasable developer.

10. The image forming apparatus according to claim 7, wherein the control unit controls the heating unit such that the heating temperature of the heating unit falls within the fourth temperature range when image forming unit forms an image on the second recording medium using the inerasable developer.

11. An image forming apparatus comprising:
an image forming unit that forms an image on a recording medium using either one of a color-erasable developer or a color-inerasable developer;
a sheet feeding unit that feeds either one of a first recording medium of which both surfaces are not formed with an image or a second medium of which one surface is formed with an image using the erasable developer and the other surface is not formed with an image, to the image forming unit; and
a heating unit that, when the image forming unit forms an image using the inerasable developer on the second recording medium fed by the sheet feeding unit, heats the image on the second recording medium to fix the image formed on the second recording medium by the image forming unit on the second recording medium and also to erase the image formed on the one surface of the second recording medium.
